(19) United States
(12) Patent Application Publication
(10) Pub. No.: US 2011/0174954 A1
(43) Pub. Date: Jul. 21, 2011

(54) BOOKSHELF PICTURE HANGER

(76) Inventor: Denise Paula Feldman, Encino, CA (US)

(21) Appl. No.: 12/689,099

(22) Filed: Jan. 18, 2010

(51) Int. Cl. A47G 1/16; B23P 11/00

(52) U.S. Cl. 248/475.1; 29/428

(57) ABSTRACT

A shelf picture hanger. This invention has a U-shaped member designed to fit snugly over a shelf. The U-shaped member has a substantially planar top, a substantially planar bottom, and a substantially planar end running between and substantially perpendicular to the top and the bottom. A picture hook is affixed to or formed integrally with the end, and a soft material, such as felt, is affixed to and lines the interior of the member. The separate picture hook may be a safety picture hook. The free end of the integral hook may be pointed or rounded. The integrally formed hook may be at an angle to the end or run parallel to it.

### BACKGROUND OF THE INVENTION

(1) Field of the Invention

The present invention relates to the field of interior decoration and more particularly to the field of picture hangers.

(2) Description of the Related Art

People like to hang pictures and other objects d'art on the interior walls of their houses for decorative purposes. This is fairly simple to do with a picture hook that is nailed into the wall. If, however, it is desired to hang a picture where there are shelves mounted on the wall, the situation becomes more complex. Inventors have tried to solve this problem in a number of ways.

U.S. Pat. No. 6,378,827 is directed to a clip for securing decorative items to the edges of household surfaces. Referring to the Figures, clip 10 is configured to clip onto a household planar surface such as a shelf, window sill, or mantle. Clip 10 is formed of a single piece of resilient material so that it may be opened to fit over the support surface and then contract to hold the clip and hanging article in place. Clip 10 includes a support arm 12 which rests on top of the surface so that it extends to a sufficient length to counterbalance the weight of the article placed upon hook 20. Protective layers 22 and 24 may be used to protect the surface when the clip 10 is in place.

U.S. Pat. No. 1,856,847 is directed to an article holder, and as seen in the Figures, is designed to fit over the edge of the table 16 which is an example of a planar surface corresponding to the shelf seen in your disclosure material. The holder, as seen in the Figures, is formed from strips of sheet metal that are bent into angles such that a supporting arm 12 extends from the table-plate 10 and continues to a lower end 13 that is formed into a V-shape in order to hold an article. Spring clamping member 14 serves to hold the device in position on the flat surface and is fitted with a cushion-pad 15.

U.S. Pat. No. 3,772,742 is directed to a shelf clip to support a razor. Referring to FIG. 2, the clip 10 is shaped into arms 16 and 18 to form a V-shaped clip that clamps onto shelf 12. A lower arm 24 extends as part of clip 10 in order to hold a razor or another item onto the shelf 12.

U.S. Pat. No. 7,316,089 is directed to a clip-on price channel. Referring to the Figures, we see that the device is configured to slide onto a shelf or other horizontal surface in order to hold an item such as a label holder 3 in place on the external edge of the shelf.

U.S. Pat. Nos. D339,980, D339,981 and 6,682,032 are other examples of devices that are configured to hold pictures or other items in place on planar surfaces around the home.

Unfortunately the above referenced prior art necessitates the need to nail into or otherwise damage wooden shelving if it is desired to hang a picture therefrom. This is a particular problem if the wood is very decorative and expensive. Development of a picture hanger which will allow people to hang pictures from shelving without damage represents a great improvement in the field interior decoration and satisfies a long felt need of the interior decorator and the public.

### SUMMARY OF THE INVENTION

The present invention is a shelf picture hanger. This invention has a U-shaped member designed to fit snugly over a shelf. The U-shaped member has a substantially planar top, a substantially planar bottom, and a substantially planar end running between and substantially perpendicular to the top and the bottom. A picture hook is affixed to or formed integrally with the end, and a soft material, such as felt, is affixed to and lines the interior of the member. The free end of the integral hook may be pointed or rounded. The integrally formed hook may be at an angle to the end or run parallel to it.

The shelf picture hanger is preferably formed of thin sheet metal by stamping. The integral hook may be die cut and also formed by stamping.

An appreciation of the other aims and objectives of the present invention and an understanding of it may be achieved by referring to the accompanying drawings and description of a preferred embodiment.

### BRIEF DESCRIPTION OF THE DRAWINGS

FIG. 1 is a front elevational view of a first embodiment of a picture hanger of this invention.

FIG. 1A is a side elevational view along the lines A-A of FIG. 1.

FIG. 1B is a side elevational view along the lines B-B of FIG. 1.

FIG. 1C is a top elevational view along the lines C-C of FIG. 1.

FIG. 1D is a bottom elevational view along the lines D-D of FIG. 1.

FIG. 2 is a front elevational view of a second embodiment of a picture hanger of this invention.

FIG. 2A is a side elevational view along the lines A-A of FIG. 2.

FIG. 2B is a side elevational view along the lines B-B of FIG. 2.

FIG. 2C is a top elevational view along the lines C-C of FIG. 2.

FIG. 2D is a bottom elevational view along the lines D-D of FIG. 2.

FIG. 3 is a front elevational view of a third embodiment of a picture hanger of this invention.

FIG. 3A is a side elevational view along the lines A-A of FIG. 3.

FIG. 3B is a side elevational view along the lines B-B of FIG. 3.

FIG. 3C is a top elevational view along the lines C-C of FIG. 3.

FIG. 3D is a bottom elevational view along the lines D-D of FIG. 3.

FIG. 4 is a front elevational view of a fourth embodiment of a picture hanger of this invention.

FIG. 4A is a side elevational view along the lines A-A of FIG. 4.

FIG. 4B is a side elevational view along the lines B-B of FIG. 4.

FIG. 4C is a top elevational view along the lines C-C of FIG. 4.

FIG. 4D is a bottom elevational view along the lines D-D of FIG. 4.

FIG. 5 is a front elevational view of a fifth embodiment of a picture hanger of this invention.

FIG. 5A is a side elevational view along the lines A-A of FIG. 5.

FIG. 5B is a side elevational view along the lines B-B of FIG. 5.

FIG. 5C is a top elevational view along the lines C-C of FIG. 5.

FIG. 5D is a bottom elevational view along the lines D-D of FIG. 5.

FIG. 6 is a cross-sectional view of the fourth embodiment installed on a shelf.

FIG. 6A is a side elevational view of the fourth embodiment installed on a shelf.

FIG. 7 is a front elevational view of a sixth embodiment of a picture hanger of this invention.

FIG. 7A is a side elevational view along the lines A-A of FIG. 7.

FIG. 7B is a side elevational view along the lines B-B of FIG. 7.

FIG. 7C is a top elevational view along the lines C-C of FIG. 7.

FIG. 7D is a bottom elevational view along the lines D-D of FIG. 7.

FIG. 8 is a front elevational view of a seventh embodiment of a picture hanger of this invention.

FIG. 8A is a side elevational view along the lines A-A of FIG. 8.

FIG. 8B is a side elevational view along the lines B-B of FIG. 8.

FIG. 8C is a top elevational view along the lines C-C of FIG. 8.

FIG. 8D is a bottom elevational view along the lines D-D of FIG. 8.

FIG. 9 is a front elevational view of a eighth embodiment of a picture hanger of this invention.

FIG. 9A is a side elevational view along the lines A-A of FIG. 9.

FIG. 9B is a side elevational view along the lines B-B of FIG. 9.

FIG. 9C is a top elevational view along the lines C-C of FIG. 9.

FIG. 9D is a bottom elevational view along the lines D-D of FIG. 9.

FIG. 10 is a front elevational view of a ninth embodiment of a picture hanger of this invention.

FIG. 10A is a side elevational view along the lines A-A of FIG. 10.

FIG. 10B is a side elevational view along the lines B-B of FIG. 10.

FIG. 10C is a top elevational view along the lines C-C of FIG. 10.

FIG. 10D is a bottom elevational view along the lines D-D of FIG. 10.

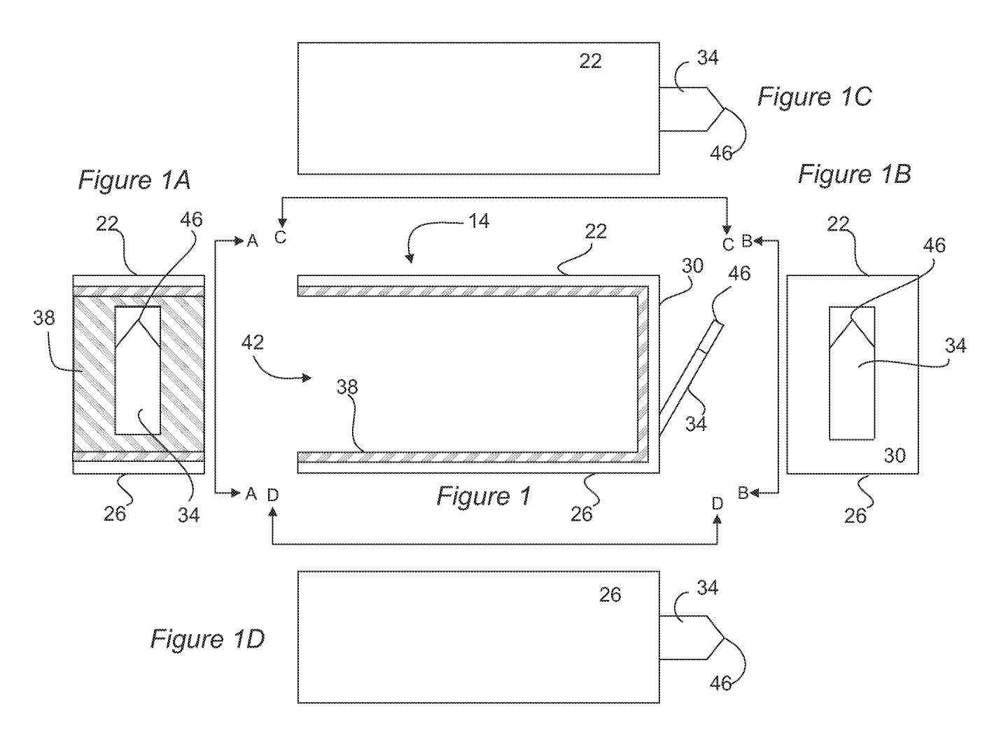

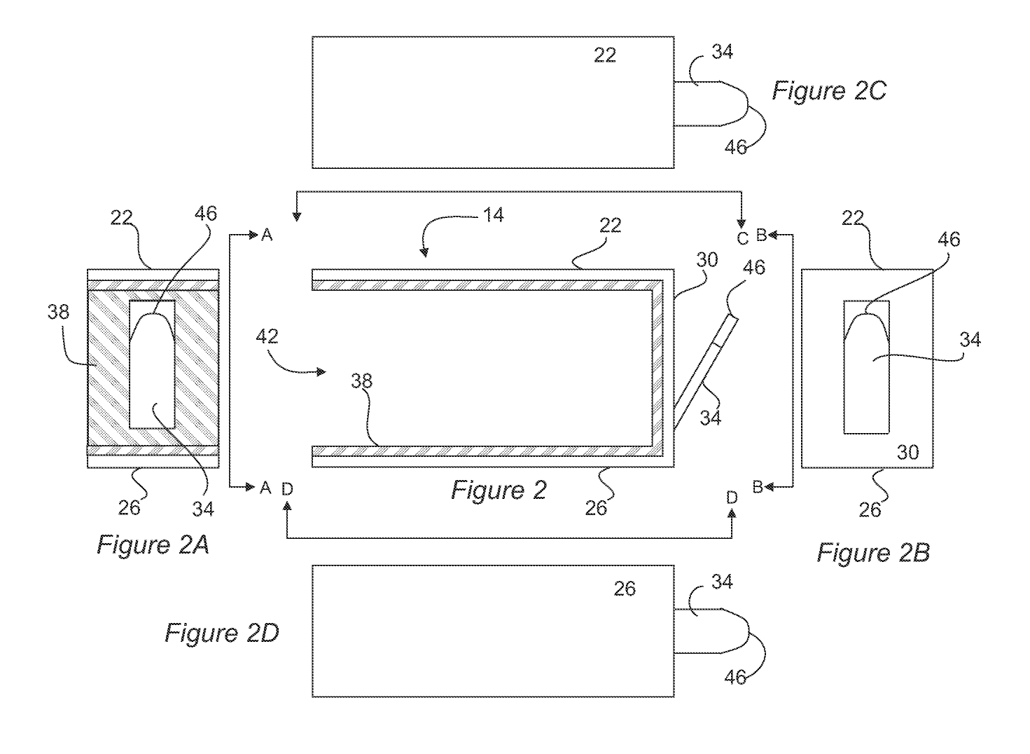

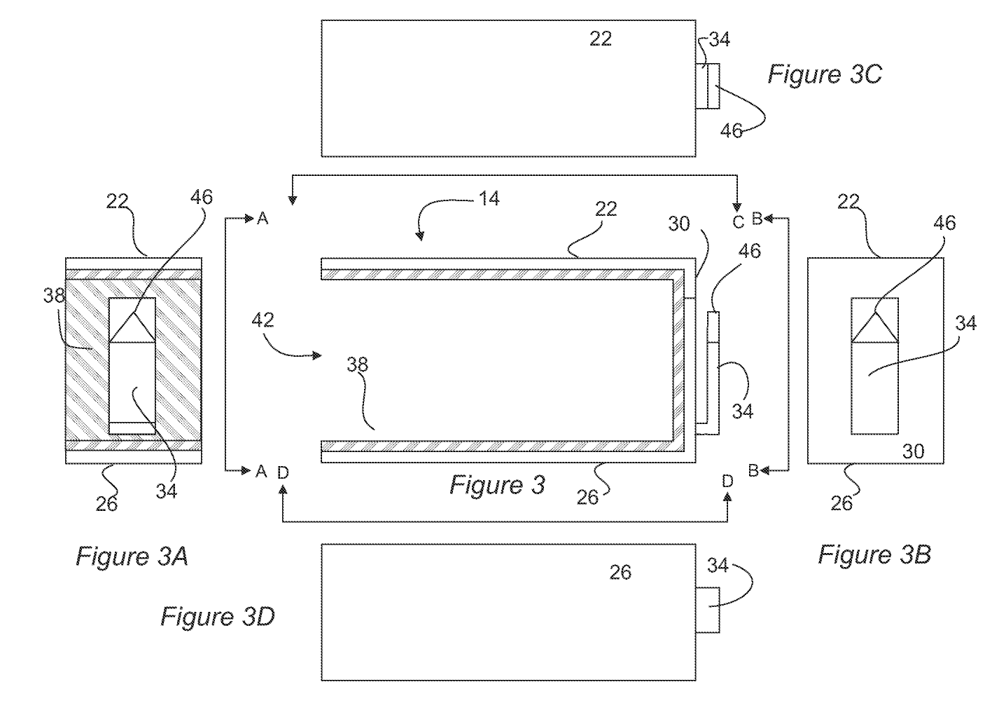

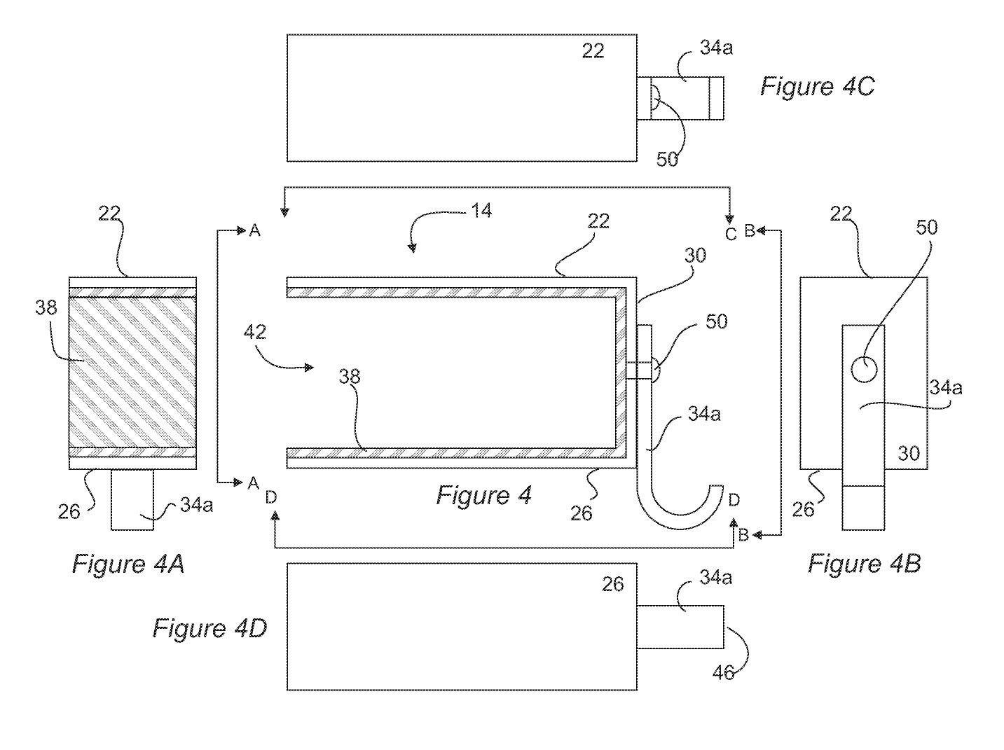

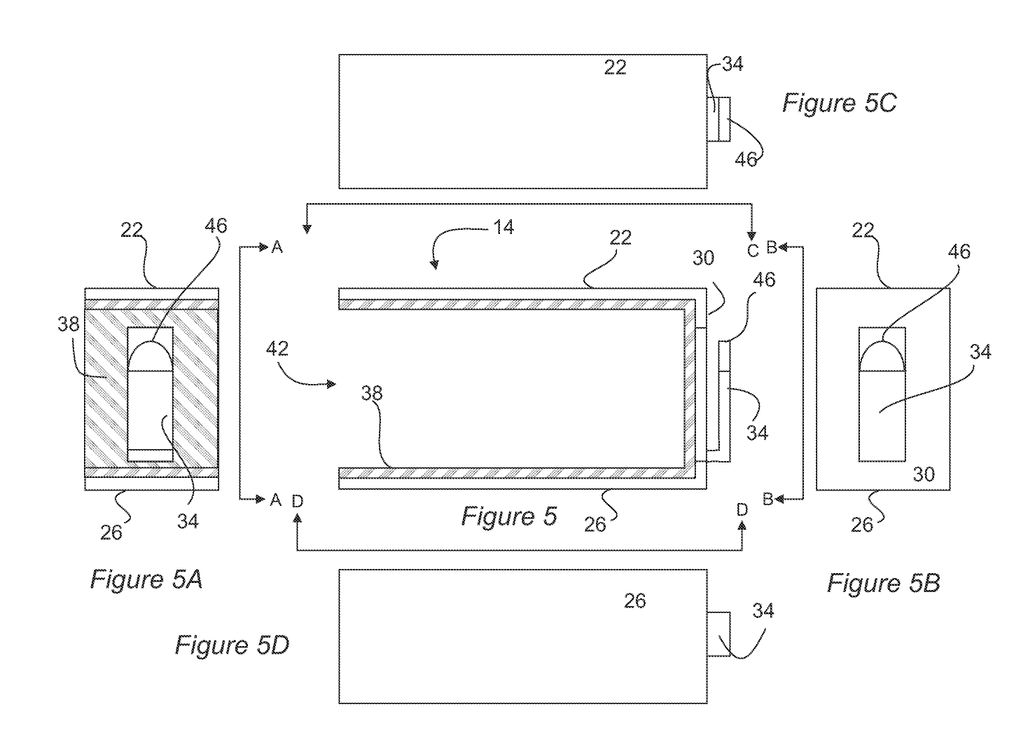

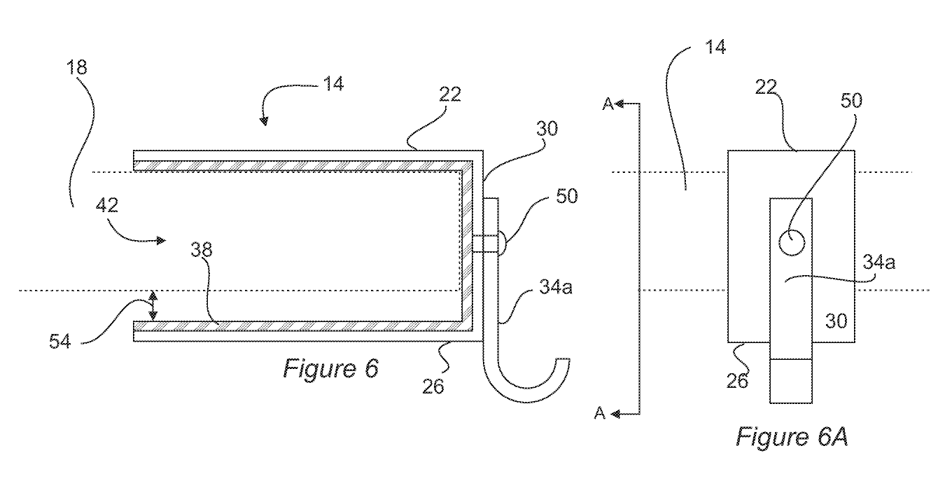

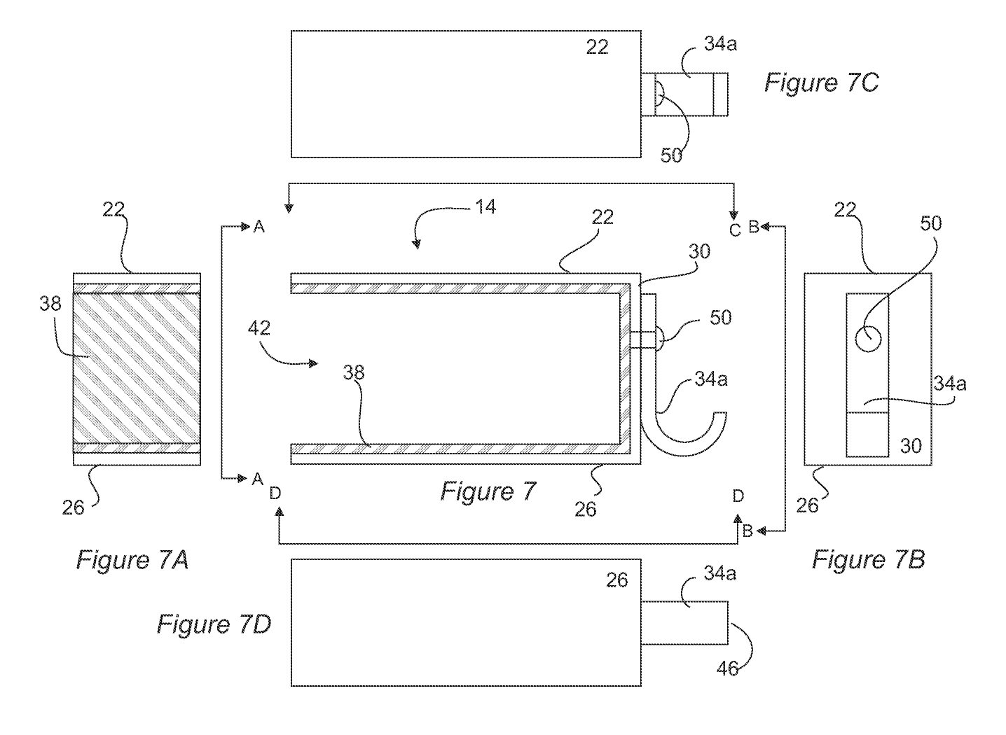

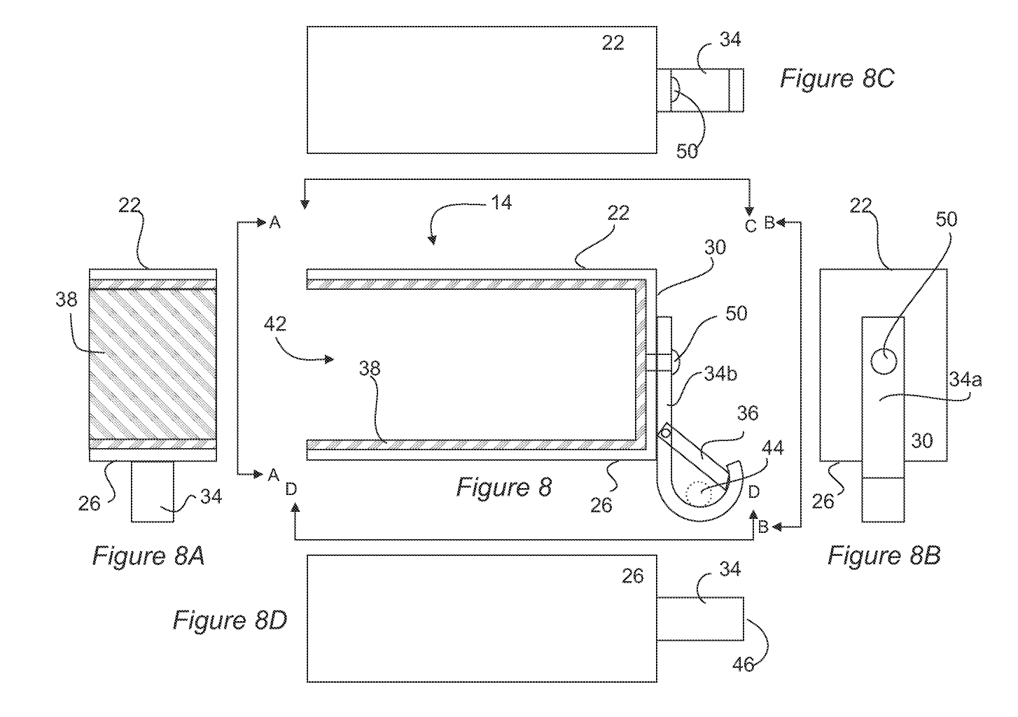

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Referring to the Figures, this invention comprises a U-shaped member 14 designed to fit snugly over a shelf 18. It has a substantially planar top 22, a substantially planar bottom 26, and a substantially planar end 30 running between and substantially perpendicular to the top 22 and the bottom 26. A picture hook 34, 34a, 34b is affixed to or formed integrally with the end 30 and a soft material 38 is preferably affixed to and lines the interior 42 of the member 14. The soft material 38 can be felt, natural rubber, silicone rubber, other soft plastic, flock, or a paraffin/polyethelene wax blend. The soft material 38 can be sheeting that is glued into place or a coating that is sprayed on, applied by powder coating or applied by dip. Those that are familiar with the art to which this invention pertains will realize that many commercially available materials can be used for this purpose.

For example, Plasti Dip International of Blaine, Minn. manufactures a number of plastic coatings that would function well as the soft material 38. A number of flocks are available. For example, Nylon®, Rayon® and polyester flocks are available from Cellusuede Products, Inc. of Rockford, Ill. A paraffin/polyethelene wax blend is available under the brand name Resisto Coat™ Plus from Michelman, Inc. of Cincinnati, Ohio. The purpose of the soft material 38 is to prevent marring of the shelf

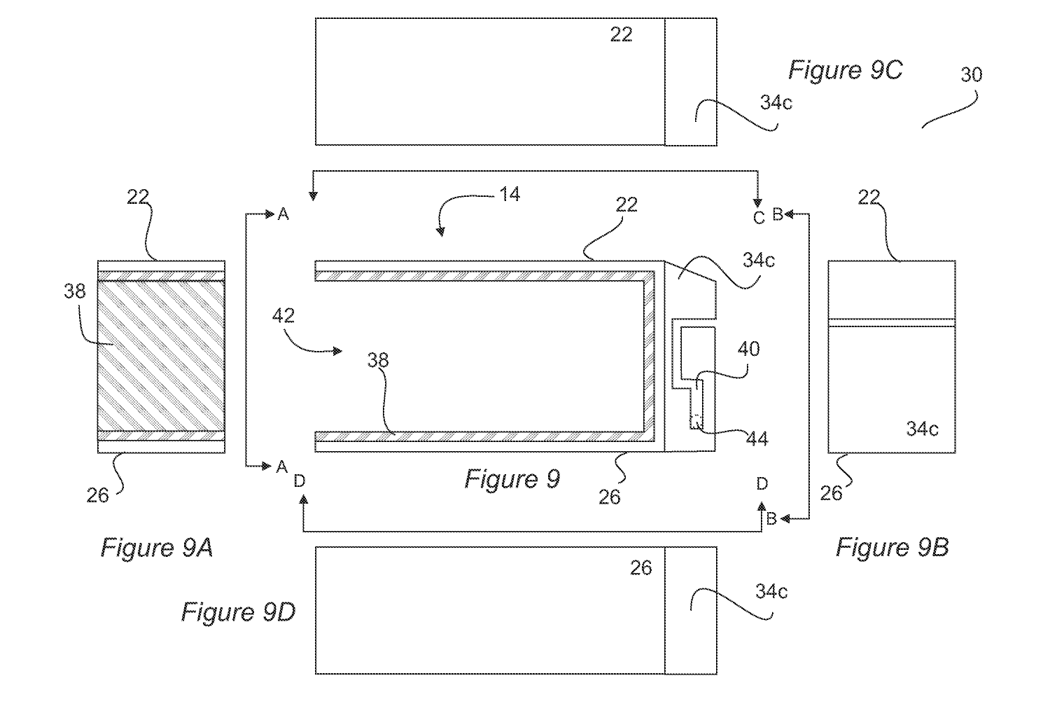

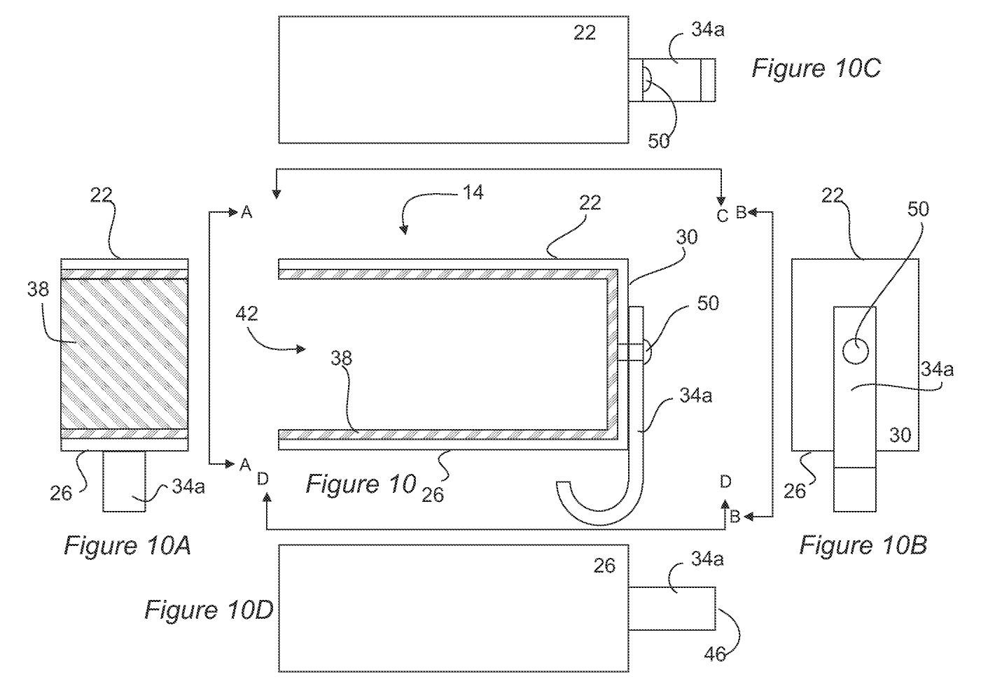

The free end 46 of the integral hook 34 may be pointed or rounded. The integrally formed hook 34 may be at an angle to the end 30 or run parallel to it. The separate hook 34a, 34b is preferable fastened to the end 30 by some sort of fastener such as a screw or rivet 50. Alternatively the separate hook 34a, 34b may be welded or adhesively bonded to the end 30. The longer hook 34a, could even be fastened with the hook pointing backwards under the U-shaped member. The safety hook 34b has an additional spring loaded bail 36, similar to the construction of a jewelry clasp, which is intended to keep picture wire 44 within the hook 34b and prevent the picture from falling in case of an earthquake. Another type of safety hook 34c is shown on FIGS. 9-9D. This one 34c has a maze 40 which prevents the wire 44 from jumping out. This design 34c can be attached to the end 30 or made integral with the end 30.

The shelf picture hanger is preferably formed of thin sheet metal by stamping. The integral hook 34 may be die cut and also formed by stamping. Although the coated member 14 should fit snugly to the shelf 18, it has been found that this invention will work with a gap 54 of up to 1.25 inches between the bottom of the shelf 18 and the soft material.

The following reference numerals are used on the Figures:

14 U-shaped member

18 shelf

22 top of U-shaped member

26 bottom of U-shaped member

30 end of U-shaped member

34 picture hook

34a separate picture hook

34b separate safety picture hook with bail

34c safety picture hook with bail

36 spring loaded bail

38 soft material

40 maze

42 interior of U-shaped member

44 picture wire

46 free end of integral hook

50 fastener

54 gap

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A shelf picture hanger comprising:
a) a U-shaped member adapted to fit over said shelf; said member having a substantially planar top, a substantially planar bottom and a substantially planar end running between and substantially perpendicular to said top and said bottom; said U-shaped member having an interior and an exterior; and
b) a picture hook appended to said end.

2. A shelf picture hanger as claimed in claim further comprising a soft material affixed to said interior.

3. A shelf picture hanger as claimed in claim 2 in which said soft material is selected from the group comprising felt, natural rubber, silicone rubber, a soft plastic, flock, and a paraffin/polyethelene wax blend.

4. A shelf picture hanger as claimed in claim 1 in which said picture hook is a safety picture hook.

5. A shelf picture hanger as claimed in claim 1 in which said picture hook is integral with said end.

6. A shelf picture hanger as claimed in claim 5, in which said picture hook has a pointed free end.

7. A shelf picture hanger as claimed in claim 5, in which said picture hook has a rounded free end.

8. A shelf picture hanger as claimed in claim 5, in which said picture hook depends at an angle from said end.

9. A shelf picture hanger as claimed in claim 5, in which said picture hook runs parallel to said end.

10. A method of fabricating a shelf picture hanger comprising the steps of:
a) fabricating a U-shaped member adapted to fit over said shelf; said member having a substantially planar top, a substantially planar bottom and a substantially planar end running between and substantially perpendicular to said top and said bottom; said U-shaped member having an interior and an exterior; and
b) appending a picture hook to said end.

11. A method as claimed in claim 10 further comprising the step of affixing a soft material to said interior.

12. A method as claimed in claim 11 in which said soft material is one of felt, natural rubber, silicone rubber, a soft plastic, flock, and a paraffin/polyethelene wax blend.

13. A method as claimed in claim 10 in which said picture hook is a safety picture hook.

14. A method of fabricating a shelf picture hanger comprising the steps of:
a) fabricating a U-shaped member adapted to fit over said shelf; said member having a substantially planar top, a substantially planar bottom and a substantially planar end running between and substantially perpendicular to said top and said bottom; said U-shaped member having an interior and an exterior; and
b) forming a picture hook in said end.

15. A method as claimed in claim 14 further comprising the step of affixing a soft material to said interior.

16. A method as claimed in claim 15 in which said soft material is one of felt, natural rubber, silicone rubber, a soft plastic, flock, and a paraffin/polyethelene wax blend.

17. A method as claimed in claim 14, in which said picture hook has a pointed free end.

18. A method as claimed in claim 14, in which said picture hook has a rounded free end.

19. A method as claimed in claim 14, in which said picture hook depends at an angle from said end.

20. A method as claimed in claim 14, in which said picture hook runs parallel to said end.

21. A method as claimed in claim 14 in which said picture hook is a safety picture hook.
